(19) United States
(12) Patent Application Publication
(10) Pub. No.: US 2010/0060616 A1
(43) Pub. Date: Mar. 11, 2010

(54) Data line driver, display device having the data line driver, and data processing system having the display device

(76) Inventors: Hyun Jin Shin, Hwaseong-si (KR); Seung Jung Lee, Seoul (KR)

Correspondence Address: LEE & MORSE, P.C., 3141 FAIRVIEW PARK DRIVE, SUITE 500, FALLS CHURCH, VA, 22042, US

(21) Appl. No.: 12/461,895

(22) Filed: Aug. 27, 2009

(30) Foreign Application Priority Data
Sep. 5, 2008 (KR) 10-2008-0087793

(51) Int. Cl. G06F 3/038

(52) U.S. Cl. 345/204

(57) ABSTRACT

A data line driver having a double column architecture includes a first driver cell including a first decoder, the first driver cell being connected to a first data line, and a second driver cell including a second decoder adjacent to the first decoder, the second driver cell being connected to a second data line.

### BACKGROUND

1. Field

Example embodiments relate to a semiconductor layout. More particularly, example embodiments relate to a data line driver having a new architecture, a display device including the data line driver, and a data processing system including the display device.

2. Description of the Related Art

A data line driver, i.e., a source driver, drives data lines, i.e., source lines, installed in a display panel in order to display image data on the display panel. A conventional data line driver may include a plurality of driver cells.

Reduction of a pitch of the driver cells may be effective to reduce a size of the data line driver. However, when a pitch of driver cells is reduced by a critical value or greater in a conventional data line driver, a size of a long edge of the data line driver may be reduced, whereas a size of a short edge of the data line driver may be increased.

### SUMMARY

Embodiments are therefore directed to a data line driver having a new architecture, a display device including the data line driver, and a data processing system including the display device, which substantially overcome one or more of the problems due to the limitations and disadvantages of the related art.

It is therefore a feature of an embodiment to provide a data line driver having a layout configuration of driver cells capable of reducing sizes of both long and short edges of the data line driver.

It is therefore another feature of an embodiment to provide a display device including a data line driver having a layout configuration of driver cells capable of reducing sizes of both long and short edges of the data line driver.

It is yet another feature of an embodiment to provide a data processing system including a display device with a data line driver having a layout configuration of driver cells capable of reducing sizes of both long and short edges of the data line driver.

At least one of the above and other features and advantages may be realized by providing a data line driver having a double column architecture, including a first driver cell having a first decoder and driving a first data line, and a second driver cell having a second decoder adjacent to the first decoder and driving a second data line. The first driver cell may further include a first output pad connected to the first data line, a pitch of the first driver cell being equal to a pitch of the first output pad.

A sum of a pitch of the first decoder and a pitch of the second decoder may be less than or equal to a pitch of the first output pad. A pitch of the second decoder may be less than or equal to a pitch of the first output pad. The first decoder and the second decoder may be arranged to be symmetrical with each other about a horizontal axis or a vertical axis. The first and second decoders may be arranged to define a single decoder block between the first and second driver cells, the first and second driver cells being adjacent to each other along a first direction, and a pitch of the single decoder block along a second direction perpendicular to the first direction being substantially equal a pitch along the second direction of an output pad connected to the first and/or second driver cell. The first and second decoders may be adjacent to each other along the second direction, a sum of a pitch of the first decoder and a pitch of the second decoder along the second direction being substantially equal a pitch of the output pad connected to the first and/or second driver cell. The first and second decoders may be adjacent to each other along the first direction, a pitch of each of the first decoder and second decoders along the first direction being less than or equal to a pitch of the output pad connected to the first and/or second driver cell.

The data line driver may further include an output pad between each of the first and second data lines and a corresponding first and second driver cell, the first and second driver cells with respective output pads being aligned along a first direction, and a pitch of each of the first and second driver cells being substantially equal to a pitch of the output pads along a second direction perpendicular to the first direction. The first driver cell may include a first buffer buffering a signal output from the first decoder, a first output pad connected between the first buffer and the first data line, and a first signal transmission circuit connected between the first buffer and the first decoder. The second driver cell may include a second buffer buffering a signal output from the second decoder, a second output pad connected between the second buffer and the second data line, and a second signal transmission circuit connected between the second buffer and the second decoder.

At least one of the above and other features and advantages may also be realized by providing a display device, including a display panel having a first data line and a second data line, and a data line driver having a double column architecture and including a first driver cell driving the first data line and a second driver cell driving the second data line. The first driver cell may include a first decoder and the second driver cell may include a second decoder adjacent to the first decoder.

At least one of the above and other features and advantages may also be realized by providing a data processing system, including a processor generating control signals, a display panel having a first data line and a second data line, and a data line driver having a double column architecture and having a first driver cell driving the first data line in response to the control signals and a second driver cell driving the second data line in response to the control signals. The first driver cell may include a first decoder and the second driver cell may include a second decoder adjacent to the first decoder. The first driver cell may include a first output buffer and a first signal transmission circuit which are sequentially disposed between a first output pad and the first decoder. The second driver cell may include a second output buffer and a second signal transmission circuit which are sequentially disposed between a second output pad and the second decoder. The first decoder and the second decoder may be arranged to be symmetrical with each other about a horizontal axis or a vertical axis.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 illustrates a schematic block diagram of a display device including a data line driver according to an embodiment;

FIG. 2 illustrates a layout of the data line driver illustrated in FIG. 1 according to an embodiment;

FIG. 3 illustrates a layout of a comparative data line driver;

FIG. 4 illustrates a detailed, schematic layout of cell drivers in the data line driver illustrated in FIG. 2 according to an embodiment;

FIG. 5 illustrates a detailed, schematic layout of cell drivers in the data line driver illustrated in FIG. 2 according to another embodiment; and

FIG. 6 illustrates a schematic block diagram of a data processing system according to an embodiment.

### DETAILED DESCRIPTION

Korean Patent Application No. 10-2008-0087793, filed on Sep. 5, 2008, in the Korean Intellectual Property Office, and entitled: “Data Line Driver, Display Device Having the Data Line Driver, and Data Processing System Having the Display Device,” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of elements and regions may be exaggerated for clarity of illustration. It will be understood that when an element is referred to as being “between” two elements, it can be the only element between the two elements, or one or more intervening elements may also be present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein, the term “and/or” includes any and all combinations of one or more of the associated listed items and may be abbreviated as “/”. Like reference numerals refer to like elements throughout.

It will be understood that, although the terms first, second, etc. may be used herein to describe various elements, these elements should not be limited by these terms. These terms are only used to distinguish one element from another. For example, a first signal could be termed a second signal, and, similarly, a second signal could be termed a first signal without departing from the teachings of the disclosure.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

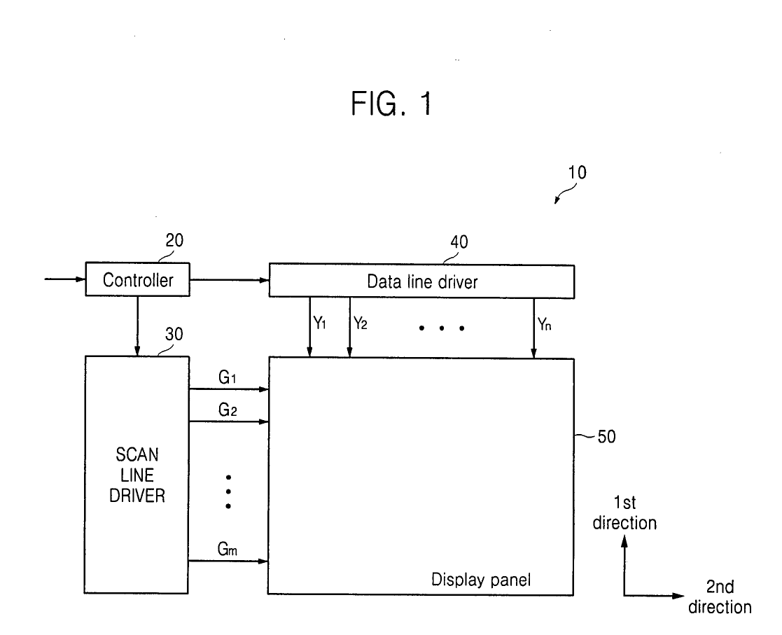

FIG. 1 illustrates a schematic block diagram of a display device 10 according to an embodiment. Referring to FIG. 1, the display device 10 may include a controller 20, a scan line driver 30, a data line driver 40, and a display panel 50.

The controller 20 may receive a plurality of system control signals and image data from an external source, and may output a plurality of control signals and image data in response to the system control signals. The controller 20 may include any suitable timing controller capable of controlling an operation of the scan line driver 30 and an operation of the data line driver 40.

The scan line driver 30, i.e., a gate line driver, may be connected to a plurality of scan lines, i.e., gate lines, G1 through Gm (m being a natural number), and may sequentially supply scan signals, i.e., driving signals, to the scan lines G1 through Gm in response to at least one of the control signals output by the controller 20. In other words, the controller 20 may output control signals to the scan line driver 30 to control application of scan signals to the scan lines G1 through Gm.

The data line driver 40, i.e., a source driver or a signal line driving circuit, may be connected to a plurality of data lines, i.e., signal lines, Y1 through Yn (n being a natural number), and may supply image signals, i.e., driving signals, to the data lines Y1 through Yn in response to at least one of the control signals output by the controller 20. In other words, the controller 20 may output control signals to the data line driver 40 to control application of image signals to the data lines Y1 through Yn. The data lines may also be called channels.

The display panel 50 may include a plurality of pixels, e.g., n×m pixels, connected between the scan lines G1 through Gm formed in a row direction of the display panel 50 and the data lines Y1 through Yn formed in a column direction of the display panel 50. The display panel 50 may be a flat display panel, e.g., a thin film transistor liquid crystal display (TFT-LCD) panel, a light emitting display panel, an organic light emitting diode (OLED) display panel, or a plasma display panel (PDP).

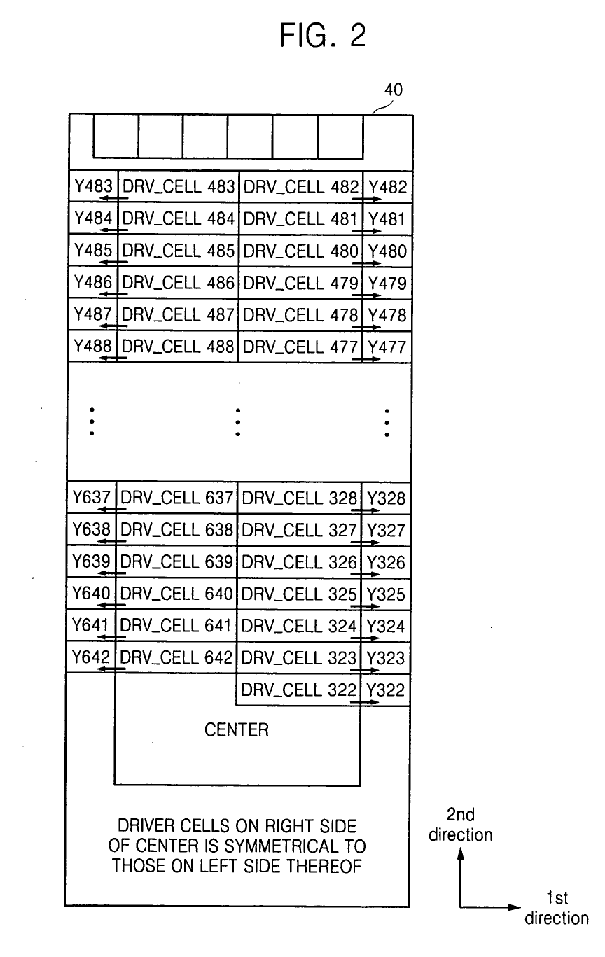

FIG. 2 illustrates a layout of driver cells in the data line driver 40 according to an embodiment. Referring to FIG. 2, the data line driver 40 may have a double column architecture of a plurality of driver cells, e.g., driver cells DRV_CELL 001 through DRV_CELL 642. The double column architecture may include a configuration where two driver cells that drive different data lines are arranged to be vertically symmetrical with each other along a first direction, i.e., an axis of symmetry between the two driver cells may extend along a second direction perpendicular to the first direction. In other words, a first plurality of driver cells may be arranged in a first columns, e.g., along the second direction, and a second plurality of driver cells may be arranged in a second column, e.g., along the second direction, adjacent to the first column along the first direction. Therefore, a driver cell in the first column may be symmetrical to a corresponding driver cells in the second column, i.e., an adjacent driver cell along the first direction. For example, as illustrated in FIG. 2, the driver cells DRV_CELL 483 through DRV_CELL 642 may be arranged in a first column and the driver cells DRV_CELL 482 through DRV_CELL 323 may be arranged in a second column adjacent to the first column, so driver cells DRV_CELL 323 and DRV_CELL 642 may be symmetrical and adjacent to each other along the first direction. Similarly, as further illustrated in FIG. 2, the driver cells DRV_CELL 482 and DRV_CELL 483 may be arranged to be vertically symmetrical and adjacent to each other along the first direction. The driver cells may also be referred to as channel drivers.

For example, some driver cells of the driver cells DRV_CELL 001 through DRV_CELL 642, e.g., DRV_CELL 001 through DRV_CELL 321, may be arranged, e.g., in two columns, on a right side of a center CENTER (not shown), where a logic control unit (not shown) is installed (or laid out). The rest of the driver cells, e.g., the driver cells DRV_CELL 322 through DRV_CELL 642 illustrated in FIG. 2, may be arranged in two columns on a left side of the center CENTER, i.e., a portion of the data line driver 40 above the center CENTER illustrated in FIG. 2. The logic control unit may control operation of respective driver cells DRV_CELL 001 through DRV_CELL 642 in response to the control signals output by the controller 20 or in response to control signals output by a processor (not shown), e.g., a central processing unit (CPU). For simplicity of illustration and convenience of explanation, FIG. 2 illustrates only the driver cells DRV_CELL 322 through DRV_CELL 642 arranged on the left side of the center CENTER. It is noted that configuration and layout of the driver cells on the right side of the of the center CENTER may be substantially the same as that on the left side of the center CENTER

As illustrated in FIG. 2, the driver cells DRV_CELL 322 through DRV_CELL 642 may be connected to corresponding output pads Y322 through Y642. According to example embodiments, a pitch of the driver cells DRV_CELL 322 through DRV_CELL 642 may equal to a pitch of the output pads Y322 through Y642, i.e., as measured along the second direction. For example, the output pads Y322 through Y642 may be arranged, e.g., in two columns, adjacent to corresponding driver cells DRV_CELL 322 through DRV_CELL 642, so each of the driver cells DRV_CELL 322 through DRV_CELL 642 may be adjacent to and aligned with a corresponding output pads Y322 through Y642. For example, as illustrated in FIG. 2, a width of each of the driver cells DRV_CELL 322 through DRV_CELL 328 along the second direction may be substantially the same as a width of each corresponding output pad Y322 through Y328 along the second direction, so each of the driver cells DRV_CELL 322 through DRV_CELL 328 may be aligned with and positioned adjacent to a corresponding output pad Y322 through Y328.

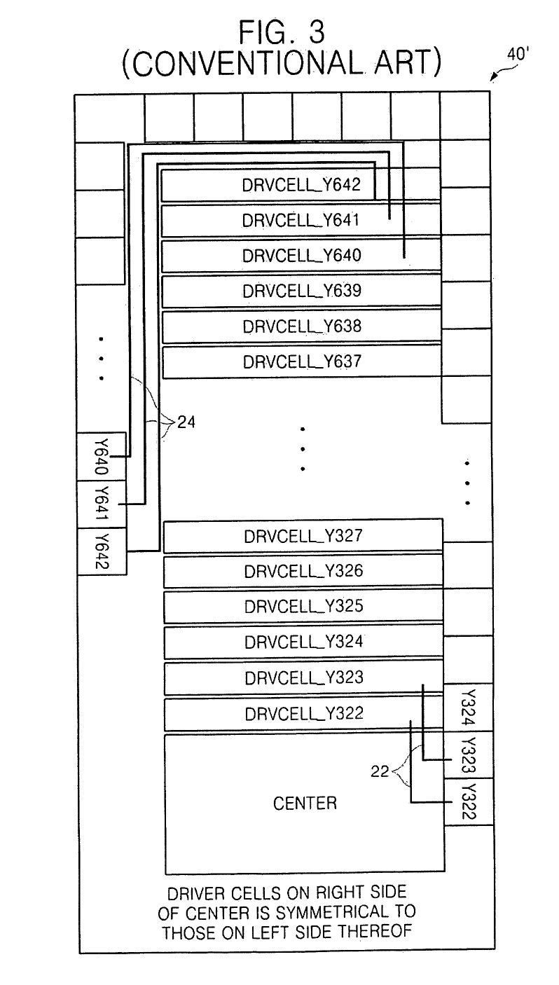

A layout of the driver cells and corresponding output pads according to example embodiments may facilitate positioning of output pads in close proximity to corresponding driver cells, thereby allowing removal of connecting wires to minimize size of the data line driver 40 and improving signal transmission. In contrast, when pitch of driver cells and output pads are different from each other, e.g., driver cells DRVCELL_Y322 through DRVCELL_Y642 with corresponding output pads Y322 through Y642 in FIG. 3, a plurality of output lines 22 and 24 may be required to transmit signals output from the driver cells DRVCELL_Y322 through DRVCELL_Y642 to respective output pads Y322 through Y642. Since the output lines 22 and 24 may have different lengths, as illustrated in FIG. 3, characteristic deviation, e.g., a slew rate or an output deviation voltage (DVO), may be generated in each of the driver cells DRVCELL_Y322 through DRVCELL_Y642. Further, an overall area of a data line driver 40′ with the output lines 22 and 24 may increase due to routing of the output lines 22 and 24.

Therefore, when pitch of the driver cells DRV_CELL 322 through DRV_CELL 642 according to example embodiments may substantially equal the pitch of the output pads Y322 through Y642, as illustrated in FIG. 2, long output lines surrounding the driver cells, e.g., the output lines 22 and 24 of FIG. 3, may be removed. Therefore, in the data line driver 40 of FIG. 2 according to example embodiments, routing issue of output lines may be removed, so a size of a long edge of the data line driver 40, i.e., a length of the data line driver 40 along the second direction, may be reduced. Moreover, since the driver cells in the data line driver 40 are aligned with corresponding output pads, line lengths connecting pairs of corresponding driver cells and output pads may be substantially the same, thereby preventing or substantially minimizing characteristic deviations of the driver cells.

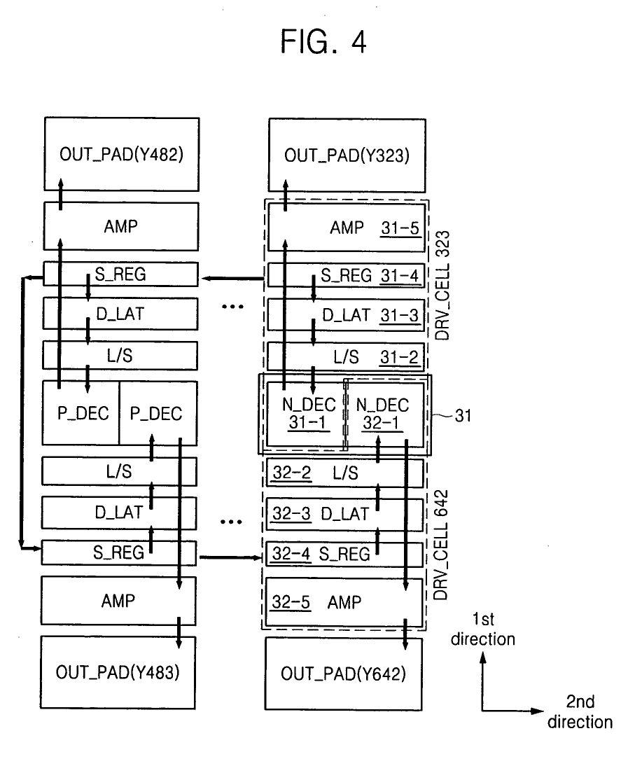

FIG. 4 illustrates a detailed layout of two adjacent driver cells in the data line driver 40 illustrated in FIG. 2 according to an embodiment. Referring to FIGS. 2 and 4, a first driver cell DRV_CELL 323 including a first decoder 31-1 and a second driver cell DRV_CELL 642 including a second decoder 32-1 may be arranged to be vertically symmetrical with each other along the first direction, as discussed previously with reference to FIG. 2. In other words, the first and second driver cells DRV_CELL 323 and DRV_CELL 642 may be symmetrical about a decoder block 31, i.e., a unit including both the first and second decoders 31-1 and 32-1.

The first decoder 31-1 and the second decoder 32-1 may be both integrated in the single decoder block 31. In this case, the first decoder 31-1 and the second decoder 32-1 may be disposed on the left and right sides of a horizontal axis, respectively. In other words, if the first and second driver cells DRV_CELL 323 and DRV_CELL 642 are disposed adjacent to each other along the first direction, the single decoder block 31 may extend along the second direction, i.e., a direction perpendicular to the first direction, and may be positioned between the first and second driver cells DRV_CELL 323 and DRV_CELL 642. The first and second decoders 31-1 and 32-1 may be arranged to be adjacent to each other along the second direction within the single decoder block 31. A sum of a pitch of the first decoder 31-1 along the second direction and a pitch of the second decoder 32-1 along the second direction may be smaller than or equal to a pitch of a first output pad Y323 along the second direction. The pitch of the first output pad Y323 may equal to a pitch of a second output pad Y642, and a pitch of the first driver cell DRV_CELL 323 may equal to a pitch of the second driver cell DRV_CELL 642. The pitch of the first output pad Y323 may equal to the pitch of the first driver cell DRV_CELL 323. Here, the meaning of “equal” denotes completely or substantially equal. It is noted that in some cases, the sum of the pitches of the first and second decoders 31-1 and 32-1 may be greater than the pitch of the first output pad Y323.

Although the first and second decoders 31-1 and 32-1 illustrated in FIG. 4 are of a same type, e.g., a decoder that outputs a positive gamma voltage or a negative gamma voltage, the first and second decoders 31-1 and 32-1 may be different types. For example, the first decoder 31-1 may output a positive gamma voltage, and the second decoder 32-1 may output a negative gamma voltage.

The first driver cell DRV_CELL 323 may include a first output buffer 31-5 and a first signal transmission circuit. The first output buffer 31-5 and the first signal transmission circuit may be disposed sequentially between the first output pad Y323 and the first decoder 31-1. The first output pad Y323 may be connected to a first data line. For example, the first signal transmission circuit, e.g., a first shift register, may transmit a signal output from a signal transmission circuit of a previous driver cell, e.g., a second shift register, to a signal transmission circuit of a next driver cell, e.g., a third shift register. The first signal transmission circuit may include a first shift register 31-4, a first data latch 31-3, and a first level shifter 31-2, which may be sequentially disposed between the first output buffer 31-5 and the decoder block 31 including the first decoder 31-1.

The first shift register 31-4 and the first data latch 31-3 may be low-voltage devices, and the first decoder 31-1, the first level shifter 31-2, and the first output buffer 31-5 may be high-voltage devices. The first shift register 31-4 sequentially shifts pulses in response to a start pulse for notifying an operation point of time from an external source, a control signal for controlling a data transmission direction, a shift clock signal, and the like, and may sequentially store input data in the first data latch 31-3 in response to the shift clock signal.

The first data latch 31-3 may latch data received from the first shift register 31-4. The first level shifter 31-2 may shift the level of data output from the first data latch 31-3. The first decoder 31-1 may output a gamma voltage in response to a signal output from the first level shifter 31-2. The first output buffer 31-5 may buffer the gamma voltage output from the first decoder 31-1 and may output the buffered gamma voltage to the first data line via the first output pad Y323.

The second driver cell DRV_CELL 642 may include a second output buffer 32-5 and a second signal transmission circuit, which may be sequentially disposed between the second output pad Y642 and the decoder block 31 including the second decoder 32-1. The second output pad Y642 may be connected to a second data line.

The second signal transmission circuit may include a second shift register 32-4, a second data latch 32-3, and a second level shifter 32-2 which may be sequentially disposed between the second output buffer 32-5 and the decoder block 31. The second shift register 32-4 may operate similarly with the first shift register 31-4, the second data latch 32-3 may operate similarly with the first data latch 31-3, and the second level shifter 32-2 may operate similarly with the first level shifter 31-2. The second decoder 32-1 may output a gamma voltage in response to a signal output from the second level shifter 32-2. The second output buffer 32-5 may buffer the gamma voltage output from the second decoder 32-1 and may output the buffered gamma voltage to the second data line via the second output pad Y642.

In the present embodiment, the first driver cell DRV_CELL 323 and the second driver cell DRV_CELL 642 may be arranged to be adjacent to each other along the first direction and to be vertically symmetrical with each other about the decoder block 31, i.e., the decoder block 31 may define an axis of symmetry along the second direction between the first and second driver cells DRV_CELL 323 and DRV_CELL 642. Since the driver cells according to example embodiments are arranged in two columns on each side of the center CENTER, a pitch of each of the first and second driver cells DRV_CELL 323 and DRV_CELL 642 may be less than or equal to a sum of pitches of two conventional driver cells in a data line driver of a same size and having a same number of driver cells, e.g., the driver cells DRVCELL_Y322 and DRVCELL_Y323 in FIG. 3. For example, if the pitch of the first driver cell DRV_CELL 323 equals two times a pitch of a conventional driver cell, e.g., the driver cell DRVCELL_Y322, and the height of the layout of the first and second output buffers 31-5 and 32-5 and the first and second signal transmission circuits is decreased, a height of a short edge, i.e., as measured along the first direction, of the data line driver 40 may be reduced.

A layout of driver cells in a data line driver according to example embodiments may be configured to have a double column configuration on each side of the center CENTER, and pitch of the driver cells and corresponding output pads may be substantially the same. Further, two adjacent cell drivers in respective two columns may be arranged to be symmetrical about a single decoder block. Therefore, as discussed previously, the same pitch of driver cells and output pads may facilitate reduction of size of the long edge in the data line driver, while configuration of a single decoder in pairs of adjacent cell drivers and adjustment of height of output buffers signal transmission circuits may facilitate reduction of size of the short edge in the data line driver. Accordingly, the data line driver 40 having the double column architecture according to example embodiments may shrink both sizes of its long and short edges.

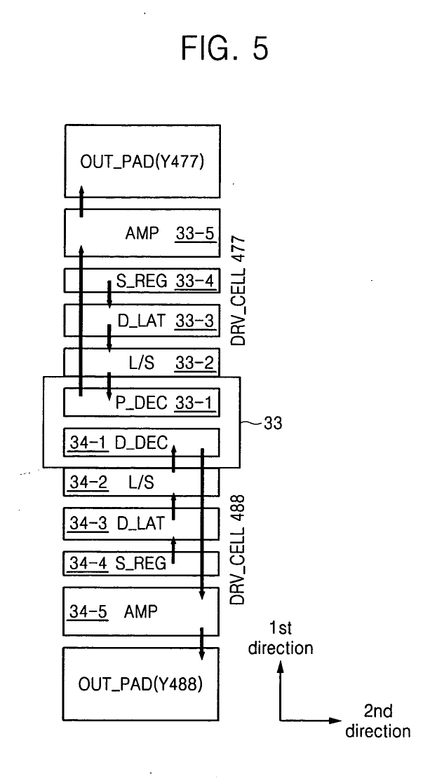

FIG. 5 illustrates another embodiment of a schematic layout of the data line driver 40 illustrated in FIG. 2. Referring to FIGS. 2 and 5, a first driver cell DRV_CELL 477 including a first decoder 33-1 and a second driver cell DRV_CELL 488 including a second decoder 34-1 may be arranged to be vertically symmetrical with each other, that is, symmetrical about a decoder block 33.

The first decoder 33-1 and the second decoder 34-1 may be both integrated in the single decoder block 33, and the first decoder 33-1 and the second decoder 34-1 may be disposed on the upper and lower sides of a horizontal axis (or an X-axis). In other words, the first and second decoders 33-1 and 34-1 may be adjacent to each other along the first direction. For example, a width of each of the first and second decoders 33-1 and 34-1 along the second direction may substantially equal a width of each of the first and second driver cells DRV_CELL 477 and DRV_CELL 488 along the second direction. In this case, a pitch of the first decoder 33-1 or a pitch of the second decoder 34-1 along the first direction may be smaller than or equal to a pitch of a first output pad Y477 or a second output pad Y488 along the first direction, respectively. According to the double column structure, the pitch of the first driver cell DRV_CELL 477 may equal the pitch of the second driver cell DRV_CELL 488. The pitch of the first driver cell DRV_CELL 477 may equal to the pitch of each of the first and second output pads Y477 and Y488.

The first driver cell DRV_CELL 477 may include a first output buffer 33-5 and a first signal transmission circuit which may be sequentially disposed between the first output pad Y477 and the first decoder 33-1. The first output pad Y477 may be connected to a first data line. The first signal transmission circuit may include a first shift register 33-4, a first data latch 33-3, and a first level shifter 33-2 which may be sequentially disposed between the first output buffer 33-5 and the first decoder 33-1.

The second driver cell DRV_CELL 488 may include a second output buffer 34-5 and a second signal transmission circuit which may be sequentially disposed between the second output pad Y488 and the second decoder 34-1. The second output pad Y488 may be connected to a second data line. The second signal transmission circuit may include a second shift register 34-4, a second data latch 34-3, and a second level shifter 34-2 which may be sequentially disposed between the second output buffer 34-5 and the second decoder block 34-1. Circuits and components in FIGS. 4 and 5 that have a same title while having different reference numerals operate substantially equally or similarly.

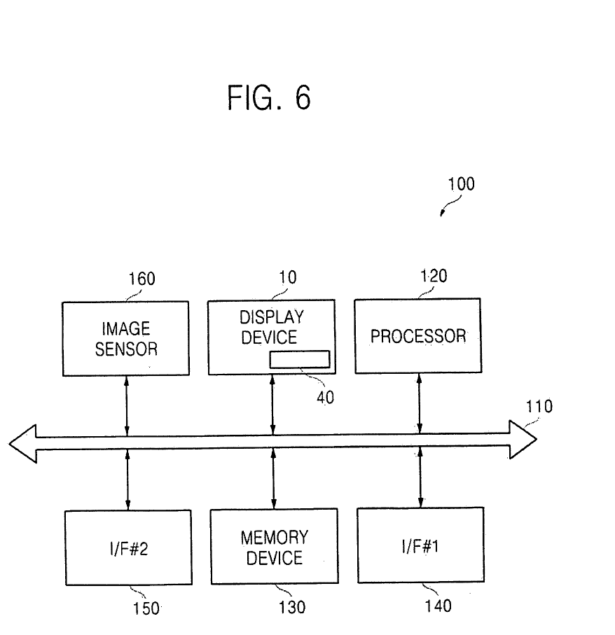

FIG. 6 illustrates a schematic block diagram of a data processing system 100 according to an embodiment. Referring to FIG. 6, the data processing system 100 may include the display device 10 and a processor 120 which may be connected to a system bus 110. The processor 120 may generate a plurality of system control signals and may transmit the system control signals to the display device 10. As described previously with reference to FIG. 1, the display device 10 may include the display panel 50 with the first data lines and second data lines, and the controller 20 which generates, in response to the system control signals output by the processor 120, a plurality of control signals for controlling the operations of the scan line driver 30 and the data line driver 40. The data line driver 40 having the double column architecture may include driver cells for driving respective data lines in response to the control signals output from the controller 20.

The processor 120 may control all operations of a memory device 130, e.g., a write operation, a read operation, and/or a verification read operation. In other words, the processor 120 may generate a command for controlling the read operation or the verification read operation of the memory device 130. Accordingly, the memory device 130 may perform an operation related with data input/output, such as a write operation, a read operation, a verification read operation, or a program operation, under the control of the processor 120. The memory device 130 may be implemented as a volatile memory device or a nonvolatile memory device. The memory device 130 may be implemented as a hard disk drive or a solid state disk.

If the data processing system 100 is implemented as a portable application, the data processing system 100 may further include a battery (not shown) for supplying operational power to the memory device 130, the processor 120, and the display device 10. Examples of the portable application may include portable computers, digital cameras, personal digital assistants (PDAs), cellular telephones, MP3 players, portable multimedia players (PMPs), automotive navigation systems, game players, electronic dictionaries, etc.

The data processing system 100 may further include an interface, e.g., an input/output device 140, to transmit and receive data to and from an external data-processing device, e.g., a personal computer (PC). If the data processing system 100 is a wireless system, the data processing system 100 may further include a wireless interface 150. In this case, the wireless interface 150 may be connected to the processor 120 and may transmit and receive data to and from an external wireless device (not shown) wirelessly via the system bus 110.

For example, the processor 120 may process data received via the wireless interface 150 and transmit the data to the memory device 130. The processor 120 may read the data stored in the memory device 130 and transmit the data to the wireless interface 150. The processor 120 may display data received through the input/output device 140 or the wireless interface 150 by using the display device 10. The wireless system may be, e.g., a PDA, a wireless portable computer, a wireless pager, a digital camera, or a Radio-Frequency IDentification (RFID) system. The wireless system may also be, e.g., a Wireless Local Area Network (WLAN) system or a Wireless Personal Area network (WPAN) system. The wireless system may also be, e.g., a mobile phone.

If the data processing system 100 is an image pick-up device, the data processing system 100 may further include an image sensor 160 which converts an optical signal into an electrical signal. The image sensor 160 may be an image sensor using a charge-coupled device (CCD) or a CMOS image sensor manufactured using a CMOS process. In this case, the data processing system 100 may display data output from the image sensor 160 by using the display device 10 under the control of the processor 120. In this case, the data processing system 100 may be a digital camera or a mobile phone to which a digital camera is attached. The data processing system 100 may also be a satellite system to which a camera is attached.

The data processing system 100 may transmit the data output from the image sensor 160 outside via the input/output device 140 and/or the wireless interface 150 under the control of the processor 120. The data processing system 100 may process the data output from the image sensor 160 and store the data in the memory device 130 under the control of the processor 120. Accordingly, the data processing system 100 may be, e.g., a digital camera or a mobile phone to which a digital camera is attached. The data processing system 100 may also be, e.g., a satellite system to which a camera is attached.

The data processing system 100 may include the display device 10 and the processor 120 and may further include at least one of the memory device 130, the input/output device 140, the wireless interface 150, and the image sensor 160 in accordance with a system implemented therein.

A data line driver having a new layout according to one or more embodiments may reduce both the sizes of its long and short edges. This leads to an increase in the number of channels. Moreover, the data line driver having a new layout according to one or more embodiments may include driver cells and output pads which may be arranged at the same pitch. Therefore, a characteristic deviation between the driver cells may be removed.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A data line driver having a double column architecture, the data line driver comprising:
a first driver cell including a first decoder, the first driver cell being connected to a first data line; and
a second driver cell including a second decoder adjacent to the first decoder, the second driver cell being connected to a second data line.

2. The data line driver as claimed in claim 1, further comprising a first output pad connected between the first data line and the first driver cell, a pitch of the first driver cell being substantially equal to a pitch of the first output pad.

3. The data line driver as claimed in claim 1, further comprising a first output pad connected to the first data line, a sum of a pitch of the first decoder and a pitch of the second decoder being less than or equal to a pitch of the first output pad.

4. The data line driver as claimed in claim 1, further comprising a first output pad connected to the first data line, a pitch of the second decoder being less than or equal to a pitch of the first output pad.

5. The data line driver as claimed in claim 1, wherein the first decoder and the second decoder are arranged to be symmetrical with each other about a horizontal axis or a vertical axis.

6. The data line driver as claimed in claim 1, wherein the first and second decoders are arranged to define a single decoder block between the first and second driver cells, the first and second driver cells being adjacent to each other along a first direction, and a pitch of the single decoder block along a second direction perpendicular to the first direction being substantially equal a pitch along the second direction of an output pad connected to the first and/or second driver cell.

7. The data line driver as claimed in claim 6, wherein the first and second decoders are adjacent to each other along the second direction, a sum of a pitch of the first decoder and a pitch of the second decoder along the second direction being substantially equal a pitch of the output pad connected to the first and/or second driver cell.

8. The data line driver as claimed in claim 6, wherein the first and second decoders are adjacent to each other along the first direction, a pitch of each of the first decoder and second decoders along the first direction being less than or equal to a pitch of the output pad connected to the first and/or second driver cell.

9. The data line driver as claimed in claim 1, further comprising an output pad between each of the first and second data lines and a corresponding first and second driver cell, the first and second driver cells with respective output pads being aligned along a first direction, and a pitch of each of the first and second driver cells being substantially equal to a pitch of the output pads along a second direction perpendicular to the first direction.

10. The data line driver as claimed in claim 1, wherein:
the first driver cell includes:
a first buffer adapted to buffer a signal output from the first decoder,
a first output pad connected between the first buffer and the first data line, and
a first signal transmission circuit connected between the first buffer and the first decoder; and
the second driver cell includes:
a second buffer adapted to buffer a signal output from the second decoder,
a second output pad connected between the second buffer and the second data line, and
a second signal transmission circuit connected between the second buffer and the second decoder.

11. The data line driver as claimed in claim 10, wherein:
the first signal transmission circuit includes:
a first shift register adapted to generate a first latch clock signal,
a first data latch adapted to latch first data in response to the first latch clock signal, and
a first level shifter adapted to shift a level of a first signal output by the first data latch and output the first signal to the first decoder; and
the second signal transmission circuit includes:
a second shift register adapted to generate a second latch clock signal,
a second data latch adapted to latch second data in response to the second latch clock signal, and
a second level shifter adapted to shift a level of a second signal output by the second data latch and output the second signal to the second decoder.

12. The data line driver as claimed in claim 1, wherein:
the first driver cell includes a first output buffer and a first signal transmission circuit, the first output buffer and first signal transmission circuit being sequentially disposed between a first output pad connected to the first data line and the first decoder; and
the second driver cell includes a second output buffer and a second signal transmission circuit, the second output buffer and second signal transmission circuit being sequentially disposed between the second decoder and a second output pad connected to the second data line.

13. A display device, comprising:
a display panel including a first data line and a second data line; and
a data line driver having a double column architecture and including a first driver cell connected to the first data line and a second driver cell connected to the second data line, the first driver cell including a first decoder, and the second driver cell including a second decoder adjacent to the first decoder.

14. The display device as claimed in claim 13, wherein:
the first driver cell further includes a first output pad connected to the first data line, a pitch of the first driver cell being equal to a pitch of the first output pad; and
the second driver cell further includes a second output pad connected to the second data line, a pitch of the second driver cell being equal to a pitch of the second output pad.

15. The display device as claimed in claim 13, wherein:
the first driver cell includes a first output buffer and a first signal transmission circuit, the first output buffer and the first signal transmission circuit being sequentially disposed between the first decoder and a first output pad connected to the first data line; and
the second driver cell includes a second output buffer and a second signal transmission circuit, the second output buffer and the second signal transmission circuit being sequentially disposed between the second decoder and a second output pad connected to the second data line.

16. A data processing system, comprising:
a processor generating control signals;
a display panel including a first data line and a second data line; and
a data line driver having a double column architecture and including a first driver cell driving the first data line in response to the control signals and a second driver cell driving the second data line in response to the control signals, the first driver cell including a first decoder, and the second driver cell including a second decoder adjacent to the first decoder.

17. The data processing system as claimed in claim 16, wherein:
the first driver cell includes a first output buffer and a first signal transmission circuit, the first output buffer and the first signal transmission circuit being sequentially disposed between the first decoder and a first output pad connected to the first data line; and
the second driver cell includes a second output buffer and a second signal transmission circuit, the second output buffer and the second signal transmission circuit being sequentially disposed between the second decoder and a second output pad connected to the second data line.

18. The data processing system as claimed in claim 16, further comprising a wireless interface connected to the processor.

19. The data processing system as claimed in claim 16, wherein the first decoder and the second decoder are arranged to be symmetrical with each other about a horizontal axis or a vertical axis.
